(19) United States
(12) Patent Application Publication
(10) Pub. No.: US 2009/0038689 A1
(43) Pub. Date: Feb. 12, 2009

(54) Three-way connecting device for tire pressure detector

(75) Inventor: Ming-Kuan Liao, Hsinchu County (TW)

Correspondence Address: BACON & THOMAS, PLLC, 625 SLATERS LANE, FOURTH FLOOR, ALEXANDRIA, VA, 22314-1176, US

(73) Assignee: MOBILETRON ELECTRONICS CO., LTD., Taichung Hsien (TW)

(21) Appl. No.: 11/882,763

(22) Filed: Aug. 6, 2007

(51) Int. Cl. F16K 15/20; B60C 29/00

(52) U.S. Cl. 137/232; 152/415

(57) ABSTRACT

A three-way connecting device for a tire pressure detector includes a three-way pipe and a nozzle. The three-way pipe has a tunnel therein, a first opening, a second opening and a third opening communicated with the tunnel, a first coupling portion around the first opening to connect an air pump to the first opening, a second coupling portion around the second opening to connect a tire pressure detector to the second opening, a third coupling portion around the third opening to connect a nozzle of a tire to the second opening. The nozzle is mounted in the first opening of the three-way pipe to be connected to the air pump. The three-way connecting device may help the inflation of tire without having to disassemble and reassemble the tire pressure detector.

### BACKGROUND OF THE INVENTION

1. Field of the Invention

The present invention relates to a tire pressure detector, and more particularly to such a three-way connecting device for an add-on tire pressure detector.

2. Description of the Related Art

A conventional add-on tire pressure detector is secured on a nozzle of a tire to detect the tire pressure. The pressure detector has a transmitter, which transmits a signal of tire pressure to inform driver.

While the tire needs to be inflated, one has to take the tire pressure detector off the nozzle to connect an air pump to the nozzle for inflation, and remount the tire pressure detector after inflation. Aforesaid steps have to repeat every time when one inflates the tire.

Typically, the truck has two or more tires side-by-side on the rear side, and the sizes of the tires are really big. It is a hard job to mount the tire pressure detector on the inner tire, so that if one has to take off and remount the tire pressure detector every time when inflate the tire, it will be a tough work for an ordinary driver who has no specific tool for it. It usually has failure when driver remount the tire pressure detector on the inner tire also. As a result, drivers usually mount no tire pressure detector on the inner tires that cause no detection on them.

### SUMMARY OF THE INVENTION

The present invention has been accomplished under the circumstances in view. It is therefore one object of the present invention to provide a three-way connecting device for a tire pressure detector, with which driver has no need to take the tire pressure detector off when he/she inflates the tire.

According to the objective of the present invention, a three-way connecting device for a tire pressure detector includes a three-way pipe and a nozzle. The three-way pipe has a tunnel therein, a first opening, a second opening and a third opening communicated with the tunnel, a first coupling portion around the first opening to connect an air pump to the first opening, a second coupling portion around the second opening to connect a tire pressure detector to the second opening, a third coupling portion around the third opening to connect a nozzle of a tire to the second opening. The nozzle is mounted in the first opening of the three-way pipe to be connected to the air pump. The three-way connecting device may help the inflation of tire without having to disassemble and reassemble the tire pressure detector.

### BRIEF DESCRIPTION OF THE DRAWINGS

FIG. 1 is a perspective view of a preferred embodiment of the present invention;

FIG. 2 is a sectional view along 2-2 line of FIG. 1; and

FIG. 3 is a sketch diagram of the present invention, showing the present invention mounted on the tire.

### DETAILED DESCRIPTION OF THE INVENTION

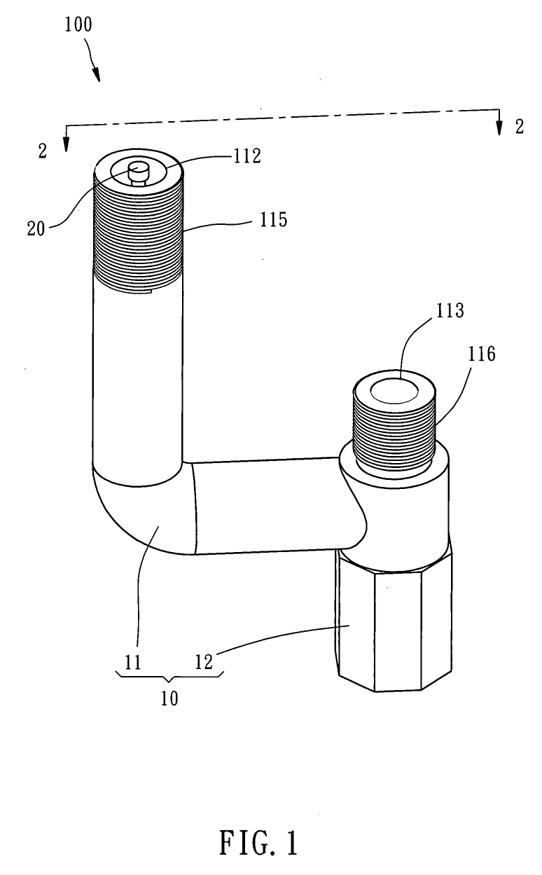

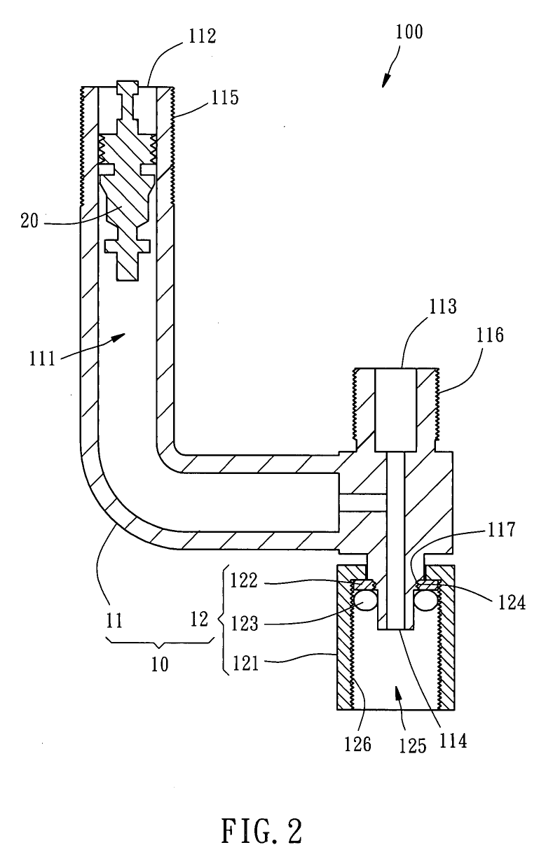

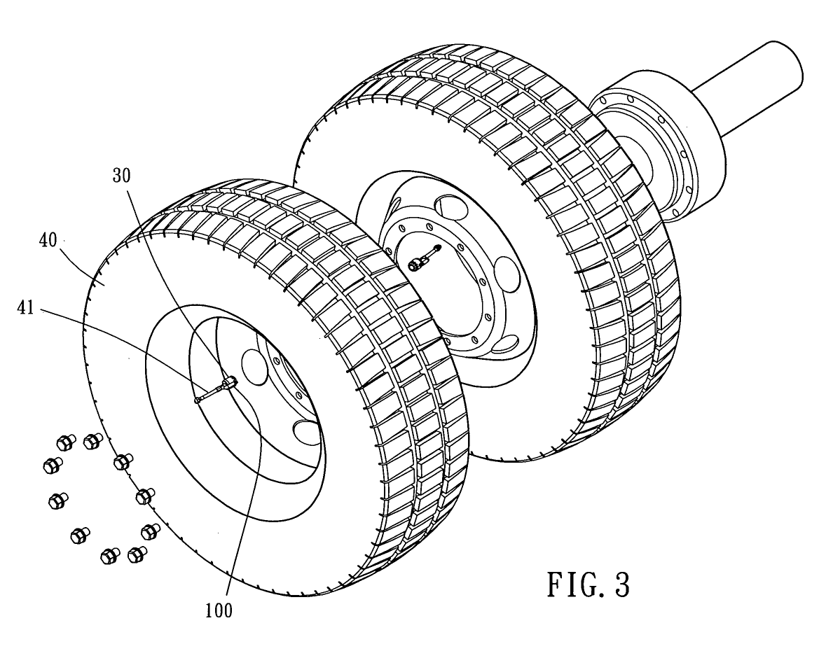

As shown in FIG. 1 to FIG. 3, a three-way connecting device 100 for an add-on tire pressure detector includes a three-way pipe 10 and a nozzle 20.

The three-way pipe 10 includes a pipe 11 and a connecting member 12. The pipe is a three-way metal pipe having a tunnel 111 therein and a first opening 112, a second opening 113 and a third opening 114 to be entrances of the tunnel 111. The pipe 11 further has a first coupling portion 115 around the first opening 112 and a second coupling portion 116 around the second opening 113. In the present invention, the first and second coupling portions 115, 116 are two outer threaded sections on a surface of the pipe 11 adjacent to the first opening 112 and the second opening 113. The pipe 11 further has a first connecting portion 117, which is an outer threaded section adjacent on the surface to the third opening 114. The connecting member 12 has a tube 121, a ring 122 and a flexible member 123. The ring 122 has a second connecting portion 124, which is an inner threaded section on an interior side thereof to be secured with the first connecting portion 117 of the pipe 11. The ring 122 is received in the tube 121 that the tube 121 may be secured onto the pipe by the ring 122 screwed onto the first connecting portion 117 of the pipe 11. The tube 121 has a secure space 125 therein, which communicated with the tunnel 111 of the pipe 11 through the third opening 114 and a third coupling portion 126, which is an inner threaded section, on an interior side thereof. The flexible member 123 is a rubber ring received in the tube 121 and fitted to the pipe 11 to provide an airtight condition when the tube 121 is connected with a nozzle 41 of an outer tire 40.

The nozzle 20 is mounted in the first opening 112 of the pipe 11 to seal the first opening 112 or let airflow entering or out of the tunnel 12 of the pipe only through the nozzle 20.

The elements of the three-way connecting device 100 are described above, and we will describe how it works in the following text.

An add-on tire pressure detector 30 is connected to the second opening 113 of the pipe 11, by an interior threaded section screwing to the second coupling portion 116 of the pipe 11, and the connecting member 12 is connected to the nozzle 41 of the tire 40 by the third connecting portion 126 in the tube 121 screwed onto an outer threaded section on the nozzle 41 that the tire 40 is communicated with the tunnel 12 of the pipe 11 through the nozzle 41, and tire pressure detector 30 may detect the pressure in the tire 40 through the tunnel 12 and transmit the tire pressure data to the driver.

While the drive needs to inflate the tire 40, a nozzle (not shown) of an air pump (not shown) may be connected to the first coupling portion 115 of the pipe 11 and press the nozzle 20 that the air pump may pump airflow to the tire 40 through the nozzle 20, the tunnel 12, the third opening 114, and the nozzle 41 of the tire 40.

With the three-way connecting device 100 of the present invention, driver may inflate the tire directly without having to take the tire pressure detector that there is no need for the difficult and complex work of assembling and disassembling the tire pressure detector in inflation of the tire. The length of the pipe 11 of the present invention may be elongated for the inner tire.

Although a particular embodiment of the invention has been described in detail for purposes of illustration, various modifications and enhancements may be made without departing from the spirit and scope of the invention.

What is claimed is:

1. A three-way connecting device for a tire pressure detector, comprising:
a three-way pipe having a tunnel therein, a first opening, a second opening and a third opening communicated with the tunnel, a first coupling portion around the first opening to connect an air pump to the first opening, a second coupling portion around the second opening to connect a tire pressure detector to the second opening, a third coupling portion around the third opening to connect a nozzle of a tire to the second opening; and
a nozzle mounted in the first opening of the three-way pipe to be connected to the air pump.

2. The three-way connecting device as defined in claim 1, wherein the three-way pipe further includes a pipe with the tunnel therein and the first opening, the second opening and the third opening on three ends thereof and a connecting member having an end connected to the third opening of the pipe and a secure space therein to be connected to the nozzle of the tire.

3. The three-way connecting device as defined in claim 2, wherein the pipe has a first coupling portion around the third opening, and the connecting member includes a tube, in which the secure space is provided and the third coupling portion is provided on an interior wall thereof, having a second coupling portion to be connected to the first coupling portion of the pipe and a ring, which is received in the tube, having a second connecting portion to be connected to the first connecting portion of the pipe.

4. The three-way connecting device as defined in claim 3, wherein the connecting member further includes a flexible member received in the secure space of the tube and fitted to the pipe to provides an airtight condition when the tube is connected to the nozzle of the tire.

5. The three-way connecting device as defined in claim 3, wherein the first connecting portion is an outer threaded section, and the second connecting portion is an inner threaded section.

6. The three-way connecting device as defined in claim 3, wherein the first coupling portion is an outer threaded section, and the second coupling portion is an outer threaded section, and the third coupling portion is an inner threaded section.
